(19) United States
(12) Patent Application Publication
(10) Pub. No.: US 2005/0049009 A1
(43) Pub. Date: Mar. 3, 2005

(54) Audio system for automobile and plug transmitter used in same

(75) Inventor: Harushige Yamamoto, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Niles Parts Co. Ltd., Tokyo (JP)

(21) Appl. No.: 10/944,906

(22) Filed: Sep. 21, 2004

Related U.S. Application Data
(63) Continuation of application No. 09/921,132, filed on Aug. 3, 2001.

(30) Foreign Application Priority Data
Aug. 8, 2000 (JP) 240102

(51) Int. Cl. H04B 1/034; H04M 1/00; H04B 1/38

(52) U.S. Cl. 455/569.2; 455/99; 455/557

(57) ABSTRACT

In the invention, it is possible to hear a voice and music of a portable audio device such as a portable telephone, an MD player, etc. in a hand free state without mounting an additional amplifier kind. Therefore, a plug transmitter is plugged into a cigar lighter socket arranged in a console portion or an arm of a side door. An external output terminal of a portable audio device such as an MD player is connected to the plug transmitter by an audio cable. A transmitting circuit is built in the plug transmitter, and receives electric power from the cigar lighter socket, and transmits an audio output from the portable audio device as a radio wave in a receiving frequency band of an AM radio mounted to an automobile. Thus, it is possible to enjoy music from a speaker within the automobile. If a portable telephone is connected to the plug transmitter, a talk can be carried out in a hand free state.

### BACKGROUND OF THE INVENTION

1. Field of the Invention

The present invention relates to an audio system for an automobile using a plug transmitter used by plugging this plug transmitter into a cigar lighter socket of the automobile.

2. Description of the Relates Art

In recent years, a portable audio device using a portable telephone, MD and CD players, or a kind of memory card such as smart media, a compact flash, a memory stick, etc. is spread together with a compression technique of an MP3 system, etc.

When these portable audio devices are utilized, an output section is basically held to one's ear, or an earphone is mounted to the ear. However, it is also desired that an operator carries the portable audio device into an automobile and can enjoy the portable audio device within the automobile. In this case, it is required that the operator can be released from pressure of the earphone, and a hand free state is set so as not to cause a hindrance in driving.

Therefore, in some automobiles, an automobile mounting audio device and having an external input pin jack is equipped, and it is possible to amplify and hear a sound by connecting the portable audio device to the automobile mounting audio device.

However, there are many automobiles equipped with an AM or FM radio, but the number of automobiles also equipped with MD and CD players, or a cassette deck kind is still small. It is not easy to mount an amplifier kind requiring considerable weight and space every kind of portable audio device so that there is no general spreading situation.

Further, there are similarly almost no mounting cases of an automobile mounting device having a dedicated card reader for carrying, inserting and regenerating only a memory card kind of a memory stick, etc. since there are problems in space and cost.

### SUMMARY OF THE INVENTION

Accordingly, in consideration of the above problems, an object of the present invention is to provide an audio system for an automobile and a plug transmitter used in this audio system in which an operator enjoys a voice, music, etc. of a portable telephone and a portable audio device in a hand free state without arranging an additional automobile mounting amplifier kind having problems in space and cost in addition to a radio almost equipped in standard.

Therefore, an audio system for an automobile in claim 1 comprises a radio mounted to the automobile; a plug transmitter plugged into a cigar lighter socket and able to input electric power from a power source mounted to the automobile; and a portable audio device connected to the plug transmitter; wherein the plug transmitter transmits an audio signal from the portable audio device as a radio wave in a receiving frequency band of the radio, and the radio receives the radio wave from the plug transmitter and performs an audio output operation from a speaker.

An external output of the portable audio device is transmitted from the plug transmitter. The radio receives this external output and performs an audio output operation from the speaker. Accordingly, it is not necessary to mount an additional amplifier kind and an operator can be released from an earphone, etc., and can hear a voice and music in a hand free state.

In the invention of claim 2, a card reading modulator portion for reading data from a memory card recording audio data and outputting the read data as an audio signal is additionally arranged in the plug transmitter; and the audio signal from the card reading modulator portion can be transmitted as a radio wave in the receiving frequency band of the radio.

The portable audio device is connected to the plug transmitter and the memory card recording music, etc. is inserted into the plug transmitter so that it is possible to simply enjoy the music, etc. through the radio.

In the invention of claim 3, a constant voltage output circuit is further arranged in the plug transmitter, and electric power can be supplied to the portable audio device connected to the plug transmitter.

The portable audio device can be operated and a battery of the portable audio device can be charged even when the battery is consumed.

In a plug transmitter of claim 4, a transmitting circuit is stored into a case having a plug-in portion able to be plugged into a cigar lighter socket; a power input terminal for inputting electric power from a power source mounted to an automobile is arranged in the plug-in portion; an input connector connected to the transmitting circuit and inputting an audio signal from a portable audio device is arranged in the case; and the transmitting circuit is operated by the electric power from the power input terminal and transmits the audio signal as a radio wave in a receiving frequency band of a radio mounted to the automobile.

The plug-in portion is plugged into the cigar lighter socket and the transmitting circuit is operated by electric power inputted from the power input terminal of the plug-in portion and transmits the audio signal toward the radio mounted to the automobile. Therefore, the plug transmitter may be set to have a small output so that the plug transmitter can be made very compact.

Further, since the audio signal is transmitted toward the radio mounted to the automobile, the plug transmitter can be widely utilized in any automobile.

In the invention of claim 5, the input connector is set to an input pin jack into which a pin of an audio cable having one end connected to an external output terminal of the portable audio device is plugged.

It is possible to arbitrarily connect various kinds of portable audio devices by the input pin jack without being limited to a specific device.

In the invention of claim 6, the input connector is set to a jack pin projected in an upper wall of the case, and the portable audio device can be held on the case by plug-in coupling with a female jack arranged in the portable audio device.

In addition to a transmitting function of the audio signal, the plug-in coupling of the jack pin and the female jack fulfills a holding function of the portable audio device. Accordingly, no audio cable is required and an arranging place of the portable audio device is determined.

In the invention of claim 7, a card reading modulator portion is connected to the transmitting circuit within the case, and a card insertion hole is formed in the case in accordance with a card insertion port of the card reading modulator portion, and the card reading modulator portion reads data from a memory card recording audio data, and outputs the read data to the transmitting circuit as an audio signal.

Music, etc. recorded to the memory card are transmitted to the radio mounted to the automobile by inserting the memory card into the plug transmitter. Accordingly, similar to a connecting case of the portable audio device, the music, etc. are outputted from the speaker of the radio.

In particular, as described in claim 8, the case is constructed by a main body for storing the transmitting circuit and an adapter portion detachably attached to the main body, and the card reading modulator portion can be arranged in the main body.

When no card reading modulator portion is required, the adapter portion is detached so that the plug transmitter is constructed by only a compact main body and is conveniently carried.

In the invention of claim 9, a constant voltage output circuit for converting the electric power inputted from the power input terminal to an external power input voltage of the portable audio device is arranged in the case, and an output power jack connected to an output of the constant voltage output circuit is arranged in the case.

Electric power is supplied from the constant voltage output circuit to the portable audio device by connecting the external power input terminal of the portable audio device to the output power jack by a power cord so that the portable audio device can be operated and charged.

### BRIEF DESCRIPTION OF THE DRAWINGS

FIG. 1 is a view showing the entire construction of a first embodiment of the present invention;

FIG. 2 is a cross-sectional view showing the structure of a plug transmitter;

FIG. 3 is a view showing the schematic construction of a transmitting circuit;

FIG. 4 is a block diagram showing a modified example of the transmitting circuit;

FIG. 5 is a view showing the construction of a second embodiment;

FIG. 6 is a cross-sectional view showing the construction of a third embodiment; and

FIG. 7 is a view showing the construction of a fourth embodiment.

### DESCRIPTION OF THE PREFERRED EMBODIMENTS

The embodiment modes of the present invention will next be explained.

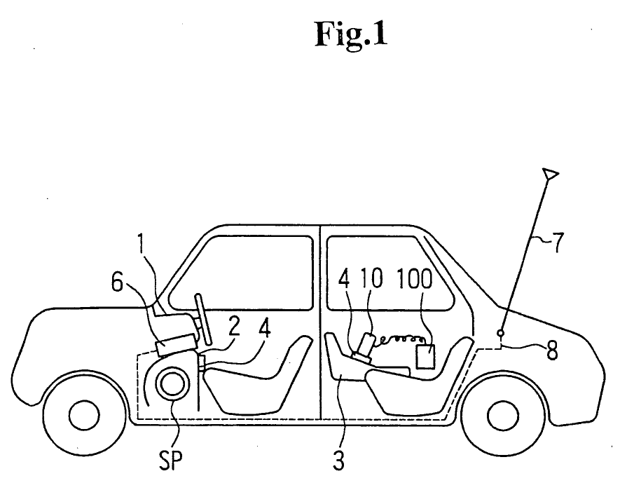

FIG. 1 is a view showing the entire construction of a first embodiment.

An AM radio 6 is equipped in an instrument panel 1 of an automobile, and its antenna 7 is arranged in a rear portion of an automobile body. The AM radio 6 and the antenna 7 are connected to each other by an antenna cable 8.

A cigar lighter socket 4 for a front seat is arranged in a console portion 2 under the instrument panel 1. A cigar lighter socket 4 for a rear seat is arranged in an arm 3 of a rear side door. A plug transmitter 10 is plugged into one of the cigar lighter sockets 4, and an MD player 100 as a portable audio device is connected to this plug transmitter 10.

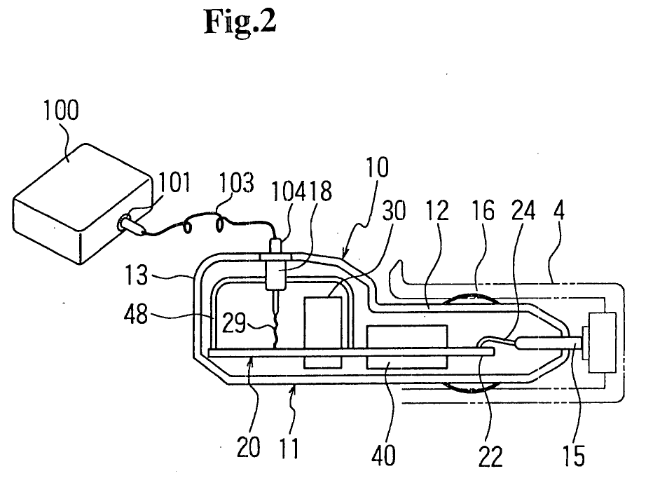

FIG. 2 is a cross-sectional view showing a structure of the plug transmitter 10 in a state in which the plug transmitter 10 is plugged into the cigar lighter socket 4.

The plug transmitter 10 is constructed such that a transmitting circuit 20 is stored into a case 11 constructed by a plug-in portion 12 plugged into the cigar lighter socket and a main body portion 13.

The plug-in portion 12 is formed in a cylindrical shape having a predetermined length, and a plus terminal 15 is projected onto a shaft core of a tip portion as a power input terminal. A minus terminal 16 is arranged in an outer circumference of the plug-in portion 12.

The main body portion 13 is swollen out with large volume with respect to the plug-in portion 12. The main body portion 13 and the plug-in portion 12 integrally form a storing space of the transmitting circuit 20 within the case 11.

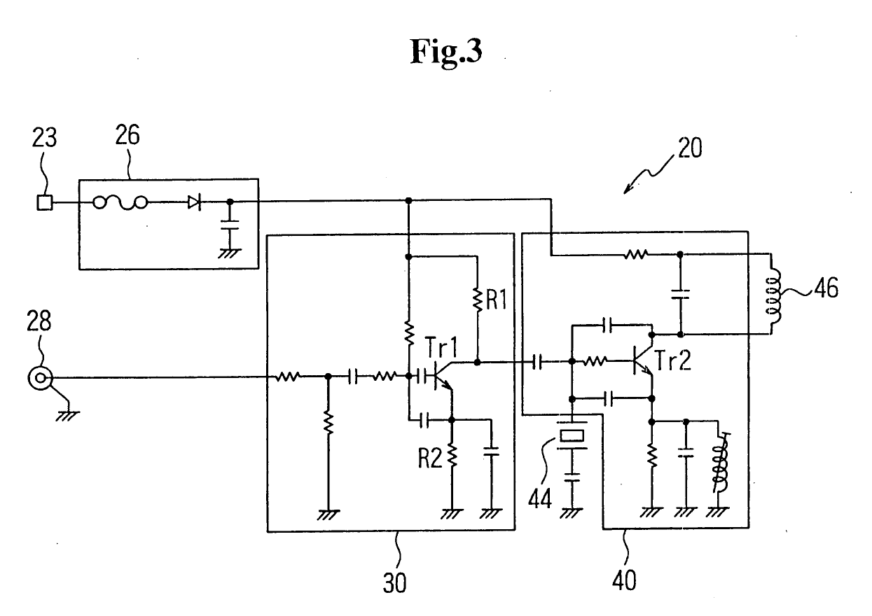

The transmitting circuit 20 is constructed by arranging an audio modulator portion 30 and a transmitter portion 40 on a print substrate 22. A power terminal 23 (see FIG. 3) of the transmitting circuit 20 is connected to the plus terminal 15 of the power input terminal by a wiring 24.

An input pin jack 18 extends through a case wall in the main body portion 13 of the case. The input pin jack 18 is connected to a signal input terminal 28 of the transmitting circuit 20 by a wiring 29 (see FIG. 3). An antenna 48 laid out along an inner wall of the main body portion 13 as an output portion of the transmitter portion 40 rises from the print substrate 22.

A pin 104 of an audio cable 103 is inserted into the input pin jack 18. One end of the audio cable 103 is connected to an external output terminal 101 such as an earphone terminal of the MD player 100.

FIG. 3 shows a schematic construction of the transmitting circuit 20.

The signal input terminal 28 is connected to the audio modulator portion 30, and an output of the audio modulator portion 30 is inputted to the transmitter portion 40. A power line 26 connected to the audio modulator portion 30 and the transmitter portion 40 is connected to the power terminal 23.

The audio modulator portion 30 forms a low frequency amplifier by a transistor Tr1 having resistors R1, R2. The resistor R1 is arranged between a collector of the transistor Tr1 and a power side, and the resistor R2 is arranged between an emitter of the transistor Tr1 and the ground. An audio signal from the MD player 100 is inputted to a base of the transistor Tr1 through the signal input terminal 28, and a voltage obtained by amplifying the audio signal is outputted to the collector.

The transmitter portion 40 forms a Pierce oscillating circuit in which a crystal oscillator 44 is arranged between the base and the emitter of a transistor Tr2. The base of the transistor Tr2 receives an output of the audio modulator portion 30, and an AM wave modulated in amplitude by an audio input is outputted from a coil antenna 46 connected to the collector of the transistor Tr2. For example, vibration frequency of the crystal oscillator 44 is set to 1620 KHz, and output intensity from the coil antenna 46 is set to that of a weak radio wave equal to or smaller than 55 dBμV/3 m determined by the Wireless Telegraphy Act.

Each of the audio modulator portion 30 and the transmitter portion 40 is sold as a chipped IC at a market, and can be easily obtained.

The plug transmitter 10 constructed in this way forms an audio system in cooperation with the AM radio 6 mounted to the automobile.

Namely, the MD player 100 is connected to the input pin jack 18 by the audio cable 103, and the plug-in portion 12 of the plug transmitter 10 having this connected input pin jack 18 is plugged into the cigar lighter socket 4 and is set. Further, a receiving frequency of the AM radio 6 is tuned to an output frequency of the plug transmitter 10.

The plug transmitter 10 transmits an output signal of the MD player 100 as a radio wave, and the AM radio 6 reliably receives this radio wave with a margin since this radio wave is weak but the plug transmitter 10 and the AM radio 6 are arranged on the same vehicle. This radio wave is then amplified through an internal amplifier, and is outputted to a speaker SP within the automobile.

Thus, music, etc. of the MD player 100 inputted from the input pin jack 18 of the plug transmitter 10 are outputted from the speaker SP of large capacity within the automobile.

In the explanation, the MD player 100 is connected to the plug transmitter 10 as an example, but an arbitrary portable audio device such as a portable telephone, a CD player, other cassette deck kinds, etc. can be also connected to the plug transmitter 10.

This embodiment is constructed as mentioned above, and the portable audio device is connected to the input pin jack 18 of the plug transmitter 10 plugged into the cigar lighter socket 4, and a signal is transmitted and is received by the radio mounted to the automobile. Accordingly, it is possible to simply comfortably enjoy a voice, music, etc. of the portable audio device through the speaker SP of large capacity within the automobile by only tuning the receiving frequency of the radio to the output frequency of the plug transmitter 10.

In this case, since the output of the plug transmitter 10 is a weak radio wave, no special qualification for a wireless equipment operation is required.

Many portable audio devices such as a portable telephone, an MD player, a CD player, a cassette deck kind, etc. can be arbitrarily connected to the plug transmitter 10 by the input pin jack 18 without being limited to a specific device, and it is not necessary to additionally arrange any dedicated amplifier kind.

In particular, a talk can be carried out in a hand free state with respect to the portable telephone if the portable telephone connected to the input pin jack 18 by a cable is stored into a chest pocket.

Further, the plug transmitter 10 is plugged into the cigar lighter socket 4 and is very compact. Accordingly, when no plug transmitter 10 is used, the plug transmitter 10 can be simply stored to a container of small articles within the automobile. The plug transmitter 10 is also easily stored into the pocket and can be easily carried so that the plug transmitter 10 can be carried into any automobile and can be utilized.

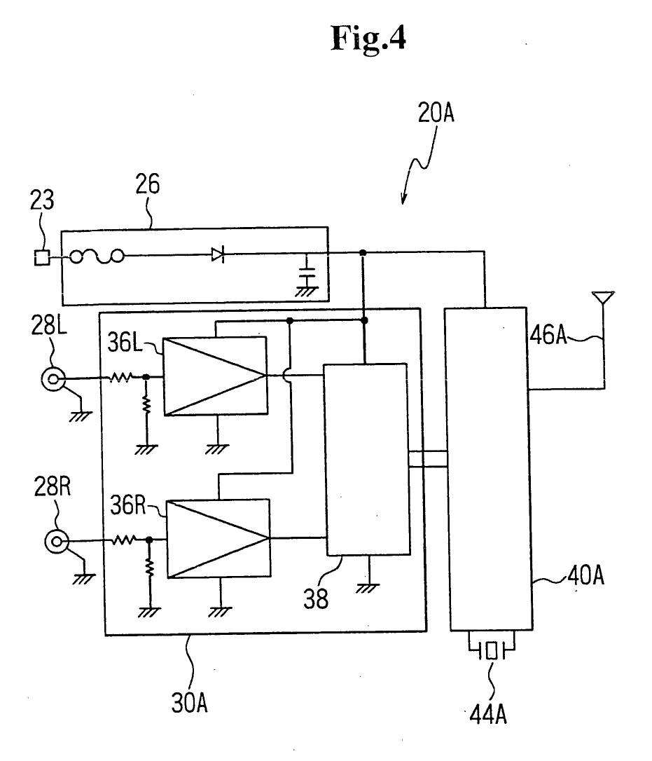

In the embodiment, the plug transmitter 10 performs an output operation by a radio wave modulated in amplitude, and this radio wave is received by the AM radio 6. However, in a modified example, as shown in FIG. 4, the transmitting circuit of the plug transmitter can be constructed by a frequency modulating system, and its output radio wave can be also received by an FM radio. If the radio mounted to the automobile can receive both the AM and FM radio waves, any modulating system may be adopted in the plug transmitter.

In a transmitting circuit 20A shown in FIG. 4, two signal input terminals 28L, 28R are arranged to divisionally input a left-hand audio signal and a right-hand audio signal, and are respectively connected to an audio modulator portion 30A. The audio modulator portion 30A has buffer amplifiers 36L, 36R in accordance with the respective signal input terminals 28L, 28R. An output of each buffer amplifier is transmitted through a frequency modulation stereo circuit 38, and a frequency modulation signal is outputted to a transmitter portion 40A.

A power line 26 connected to the audio modulator portion 30A and the transmitter portion 40A is connected to a power terminal 23 connected to a plus terminal 15.

The transmitter portion 40A is formed by a high frequency oscillating circuit using a crystal oscillator 44A. The transmitter portion 40A receives an output from the audio modulator portion 30A, and outputs an FM wave modulated in frequency on the basis of an audio input from an antenna 46A. For example, a reference frequency of the FM wave is set to 82 MHz.

Each of the frequency modulation stereo circuit and the high frequency oscillating circuit used here can be easily obtained as a chipped IC.

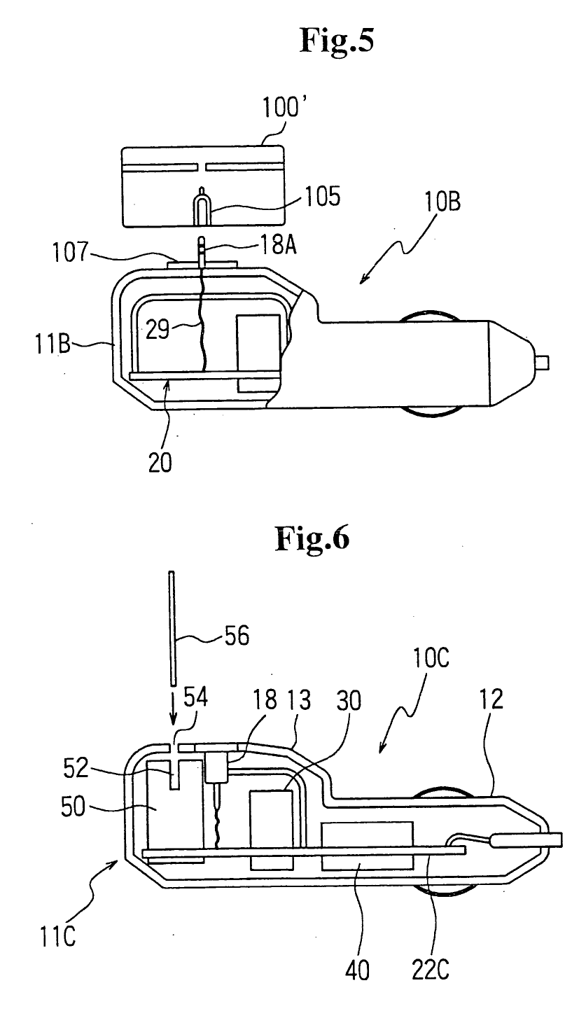

FIG. 5 shows a second embodiment. In this second embodiment, a plug transmitter 10B and a portable audio device are connected by a direct connecting system.

In the first embodiment, the input pin jack 18 is arranged in the case 11. Instead of this, in the plug transmitter 10B in this embodiment, a jack pin 18A is projected in an upper wall of a case 11B, and is connected to a signal input terminal of a transmitting circuit 20 by a wiring 29 within the case 11B.

A female jack 105 is arranged on the lower face of a portable audio device such as an MD player 100′ connected to the plug transmitter 10B. The jack pin 18A of the upper wall of the case 11B and the female jack 105 are connected to each other by plug-in coupling.

A cushion material 107 is arranged around the jack pin 18A in the upper wall of the case 11B, and prevents the generation of a rattling sound due to direct contact of the portable audio device and the case 11B of the plug transmitter.

The other constructions are the same as the first embodiment.

This embodiment is constructed as mentioned above, and the jack pin 18A is arranged in the upper wall of the case 11B of the plug transmitter 10B, and this jack pin 18A and the female jack 105 on a side of the portable audio device (MD player 100′) are coupled and connected. Accordingly, the portable audio device is held in a mounting state onto the plug transmitter 10B simultaneously when an audio signal is transmitted.

Therefore, no audio cable for connection is required, and there is no anxiety of an arranging place of the connected portable audio device within the automobile.

A third embodiment will next be explained with reference to FIG. 6. In this third embodiment, a card reading modulator portion is further built-in and added to the plug transmitter in the first embodiment.

In the plug transmitter 10C, the card reading modulator portion 50 for reading data of a memory card 56 is arranged in a position located in a main body portion 13 of a case 11C in a print substrate 22C, and is adjacent to an audio modulator portion 30. A card insertion port 52 of the card reading modulator portion 50 is directed upward.

A card insertion hole 54 corresponding to the card insertion port 52 of the card reading modulator portion is formed in the main body portion 13 of the case 11C and is adjacent to an input pin jack 18.

The card reading modulator portion 50 on the print substrate 22C converts data read from the memory card 56 to an audio signal, and outputs the audio signal to the audio modulator portion 40.

The other constructions are the same as the first embodiment.

This embodiment is constructed as mentioned above, and the card reading modulator portion 50 is arranged in the plug transmitter 10C in addition to the input pin jack 18. Accordingly, the memory card 56 recording audio data through a personal computer is inserted into the card insertion port 52 from the card insertion hole 54 so that a radio wave is outputted from the plug transmitter 10C, and is received by a radio mounted to the automobile, and its recorded music, etc. can be heard from a speaker.

Thus, an output operation from the speaker mounted to the automobile can be performed through the radio by connecting the portable audio device to the plug transmitter. Further, it is also possible to enjoy music, etc. by directly inserting only the memory card. Accordingly, general purpose property is further improved and the plug transmitter can be conveniently used.

In the illustrated example, one card insertion port 52 is formed in the card reading modulator portion 50, but plural card insertion ports corresponding to various kinds of modes of the memory card having a thin plate shape, a stick shape, etc. may be also formed in the card reading modulator portion 50.

In the above embodiment, the card reading modulator portion 50 is arranged integrally with the print substrate 22C having the audio modulator portion 30 and the transmitter portion 40, and is arranged within the case 11C of the plug transmitter 10C. However, the card reading modulator portion 50 can be set to a separate adapter, and can be also detachably attached to the plug transmitter in the first embodiment.

Thus, the card reading modulator portion 50 is arranged integrally or separately in accordance with necessity. When no card reading modulator portion is required, only the plug transmitter made compact as much as possible is arranged so that it is convenient to carry the plug transmitter.

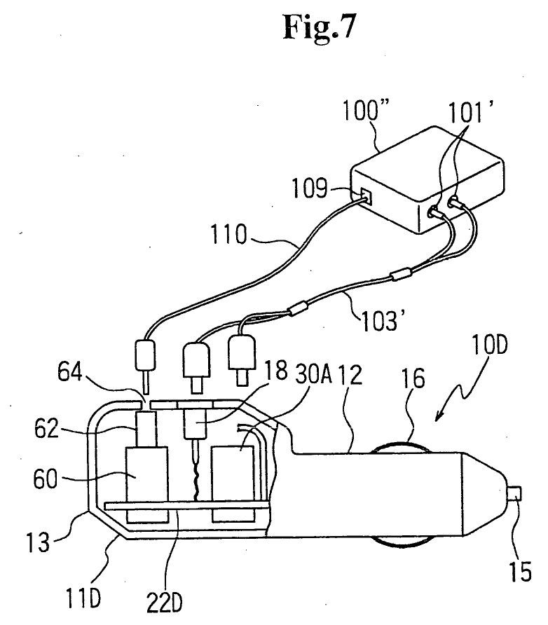

A fourth embodiment will next be explained. In this fourth embodiment, a constant voltage output circuit is built in the plug transmitter. The construction of this embodiment is shown in FIG. 7.

The constant voltage output circuit 60 is arranged in a print substrate 22D within a case 11D of a plug transmitter 10D, and is adjacent to an audio modulator portion 30A. The constant voltage output circuit 60 converts a voltage supplied from a power input terminal (a plus terminal 15 and a minus terminal 16) at a tip of a plug-in portion 12 to a voltage set to an external power input of a portable audio device, e.g., 3 to 5 V.

An insertion hole 64 of a jack of a power cord 110 described later is formed in a main body portion 13 of the case 11D and is adjacent to an input pin jack 18 such that this insertion hole 64 corresponds to an output power jack 62 of the constant voltage output circuit 60.

In this embodiment, two input pin jacks 18 not particularly illustrated are arranged in parallel with each other in a direction perpendicular to a paper face of FIG. 7, and receive a stereo signal by an audio cable 103′ constructed by two wires. The transmitting circuit 20A shown in FIG. 4 is arranged on the print substrate 22D.

The other constructions are the same as the first embodiment.

The output power jack 62 of the plug transmitter 10D plugged into a cigar lighter socket, and an external power input terminal 109 of a portable audio device such as an MD player 100″, etc. are connected to each other by a power cord 110. Thus, the above output voltage 3 to 5 V from the constant voltage output circuit 60 is supplied to the portable audio device, and the plug transmitter 10D functions as a power adapter.

In this embodiment constructed as mentioned above, an external output terminal 101′ of the portable audio device is connected to the input pin jack 18 of the plug transmitter 10D plugged into the cigar lighter socket by the audio cable 103′. Further, the external power input terminal 109 is connected to the output power jack 62 by the power cord 110. Accordingly, even when a battery of the portable audio device has been discharged, similar to each embodiment, it is possible to simply comfortably enjoy a voice, music, etc. of the portable audio device through a speaker of large capacity within the automobile by only tuning the receiving frequency of a radio to an output frequency of the plug transmitter 10D, and the battery can be charged in the meantime.

The illustrated construction in each embodiment is only one example, and various modifications can be made. For example, circuit constructions of the audio modulator portion and the transmitter portion can be selected from various circuit constructions obtained from a market. Further, an arrangement on the print substrate can be suitably determined in conformity with a shape of the case.

A transmitting frequency of the plug transmitter can be arbitrarily set to a frequency within a receiving frequency band of the radio mounted to the automobile, and plural frequencies not broadcasted normally in a running area may be set and can be also switched.

As mentioned above, in the audio system for an automobile in the present invention, a plug transmitter plugged into a cigar lighter socket and inputting electric power from a power source mounted to an automobile transmits an audio signal from a portable audio device connected to this plug transmitter as a radio wave. A radio mounted to the automobile receives the audio signal, and performs an audio output operation from a speaker. Accordingly, it is not necessary to mount an additional amplifier kind to the automobile, and an operator can be released from an earphone, etc. in the portable audio device such as a CD player, an MD player, etc., and can enjoy music. Further, for example, the operator can hear a voice in a hand free state in a portable telephone as the portable audio device.

A card reading modulator portion for reading data from a memory card recording audio data and outputting the read data as an audio signal is additionally arranged in the plug transmitter, and the audio signal from the card reading modulator portion can be transmitted as a radio wave. Accordingly, it is also possible to enjoy music, etc. recorded to the memory card through the radio mounted to the automobile by inserting the memory card into the plug transmitter.

When a constant voltage output circuit is further arranged in the plug transmitter and electric power can be supplied to the portable audio device connected to the plug transmitter, the portable audio device can be operated and a battery of the portable audio device can be charged even when the battery of the portable audio device is consumed.

In the plug transmitter of the invention, a transmitting circuit is stored into a case having a plug-in portion able to be plugged into the cigar lighter socket, and a power input terminal for inputting electric power from a power source mounted to the automobile is arranged in the plug-in portion, and an input connector connected to the portable audio device is arranged in the case. The audio signal from the portable audio device is transmitted as a radio wave in a receiving frequency band of the radio mounted to the automobile. Accordingly, the plug transmitter can be very compactly constructed, and can be briefly carried and used in an arbitrary automobile, and a voice and music, etc. of the portable audio device can be heard from the radio.

The input connector is particularly set to an input pin jack into which a pin of an audio cable having one end connected to an external output terminal of the portable audio device is plugged. Accordingly, various kinds of portable audio devices such as a portable telephone, a CD player, other cassette deck kinds, etc. can be arbitrarily connected without being limited to a specific device.

The input connector is also set to a jack pin projected in an upper wall of the case, and is plugged-in and coupled to a female jack arranged in the portable audio device. Accordingly, the audio signal is transmitted and the portable audio device is held by the plug transmitter. Therefore, there are advantages in that no audio cable for connection is required, and there is no anxiety of an arranging place of the portable audio device.

Further, a card reading modulator portion is arranged within the case, and data are read from the memory card recording audio data and are outputted as the audio signal to the transmitting circuit. In such a construction, music, etc. recorded to the memory card are transmitted to the radio mounted to the automobile, and, similar to a connecting case of the portable audio device, the music, etc. are outputted from the speaker of the radio.

In particular, the case is constructed by a main body for storing the transmitting circuit and an adapter portion detachably attached to this main body, and the card reading modulator portion is arranged in the adapter portion. In this case, when no card reading modulator portion is required, the adapter portion is detached and can be set such that only the compact main body is conveniently carried.

Further, when a constant voltage output circuit is arranged within the case of the plug transmitter and its output power jack is arranged in the case, electric power can be supplied to the portable audio device connected to the output power jack so that the portable audio device can be operated and charged.

1. An audio system for an automobile comprising:
a radio mounted to the automobile;
a plug transmitter plugged into a cigar lighter socket and able to input electric power from a power source mounted to the automobile; and
a portable audio device connected to the plug transmitter; wherein
said plug transmitter wirelessly transmits an audio signal from the portable audio device as a radio wave in a receiving frequency band of said radio, and
said radio receives the radio wave from said plug transmitter and performs an audio output operation from a speaker.

2. An audio system for an automobile according to claim 1, wherein a card reading modulator portion for reading data from a memory card, recording audio data, and outputting the read data as an audio signal is additionally arranged in said plug transmitter; and
the audio signal from the card reading modulator portion can be transmitted as a radio wave in the receiving frequency band of said radio.

3. An audio system for an automobile according to claim 1 or 2, wherein a constant voltage output circuit is further arranged in said plug transmitter, and electric power can be supplied to said portable audio device connected to the plug transmitter.

4. A plug transmitter characterized in that a transmitting circuit is stored inte a case having a plug-in portion able to be plugged into a cigar lighter socket;
a power input terminal for inputting electric power from a power source mounted to an automobile is arranged in said plug-in portion;
an input connector connected to said transmitting circuit and inputting an audio signal from a portable audio device is arranged in said case; and
said transmitting circuit is operated by the electric power from said power input terminal and wirelessly transmits said audio signal as a radio wave in a receiving frequency band of a radio mounted to the automobile.

5. A plug transmitter according to claim 4, wherein said input connector is an input pin jack into which a pin of an audio cable having one end connected to an external output terminal of said portable audio device is plugged.

6. A plug transmitter according to claim 4, wherein said input connector is a jack pin projected in an upper wall of said case, and the portable audio device is held on the case by plug-in coupling with a female jack arranged in the portable audio device.

7. A plug transmitter according to claims 4, 5 or 6, wherein a card reading modulator portion is connected to said transmitting circuit within said case,
a card insertion hole is formed in said case in accordance with a card insertion port of said card reading modulator portion, and
the card reading modulator portion reads data from a memory card recording audio data, and outputs the read data to said transmitting circuit as an audio signal.

8. An audio system for an automobile according to claim 7, wherein said case is constructed by a main body for storing said transmitting circuit and an adapter portion detachably attached to the main body, and
said card reading modulator portion is arranged in said main body.

9. A plug transmitter according to claims 4, 5, or 6, wherein a constant voltage output circuit for converting the electric power inputted from said power input terminal to an external power input voltage of the portable audio device is arranged in said case, and an output power jack connected to an output of the constant voltage output circuit is arranged in said case.

10. A plug transmitter according to claim 7, wherein a constant voltage output circuit for converting the electric power inputted from said power input terminal to an external power input voltage of the portable audio device is arranged in said case, and an output power jack connected to an output of the constant voltage output circuit is arranged in said case.
